(19) United States
(12) Patent Application Publication
(10) Pub. No.: US 2025/0385463 A1
(43) Pub. Date: Dec. 18, 2025

(54) MOBILE INDUSTRIAL SOCKET/PLUG WITH IMPROVED GASKET OF THE CABLE PASSAGE

(71) Applicant: Scame Parre S.p.A., Parre (BG) (IT)

(72) Inventor: Giovanni Mapelli, Villa di Serio (BG) (IT)

(21) Appl. No.: 18/880,593

(22) PCT Filed: Jun. 23, 2023
(86) PCT No.: PCT/IB2023/056489

§ 371 Date: Jan. 2, 2025

(30) Foreign Application Priority Data
Jul. 1, 2022 (IT) 102022000013981

(51) Int. Cl. H01R 13/52

(52) U.S. Cl. CPC H01R 13/5205

(57) ABSTRACT

A mobile industrial plug/socket comprises a body (1) bearing at one end a module and at the opposite end an annular ferrule (3) for clamping the power cable, which enters the body (1) through a gasket (4) comprising three discs (5) placed side by side and made of a styrene-ethylene-butadiene-styrene thermoplastic polymer having a hardness of ShA 25-70, each disc (5) being provided with a hole (5a) sized in such a way that sealing at the required IP rating is ensured over the full range of cables that may be wired to said socket/plug.

The present invention relates to industrial mobile sockets/plugs, and in particular to a socket/plug comprising an improved cable passage gasket with respect to the type of gasket traditionally used.

It is well known that the market offers mobile sockets/plugs for industrial use which typically have a solution relating to the gasket of the cable passage consisting of a series of concentric multi-diameter rubber rings (e.g. 5) which the user has to gradually remove as if they were the various layers of an onion (hence the name “onion rings”) until reaching the diameter suitable for sealing the cable in use. This known solution addresses the problem that the manufacturer of the socket/plug does not know which diameter of cable will be used for the end use of his product, so he must provide a wide range of gasket diameters in order to guarantee the required IP degree of insulation to prevent dirt, moisture, etc. from entering the socket/plug during use.

A similar solution requiring user intervention can be found in US 2014/299369 and FR 2689331, both documents describing a stepped truncated cone gasket with each step corresponding to a diameter of the cable to be wired. In practice, the user must cut the gasket at the correct diameter step according to the cable to be wired, in order to obtain a gasket of the specific size required for that cable.

Since the user has to cut/remove portions of the gasket that are too small for the cable he intends to use, this type of gasket has several disadvantages
the material waste of the removed portions, which once separated from the rest of the gasket are unusable;
the impossibility of reusing the socket/plug with a cable of a smaller diameter than the first cable used, as the gasket would be too wide and the seal at the required IP rating would no longer be guaranteed;
the risk of damaging the ring/step of the correct diameter when removing smaller rings/steps, thus rendering the gasket unusable;
the fact that the choice of the most suitable diameter at which to cut the gasket is left to the user who could choose the wrong diameter, with the consequence that from case to case there could be differences in the IP grade obtained.

A different solution is proposed in EP 2784887, in which a cylindrical body is provided with an external thread capable of engaging a ring with a corresponding internal thread, said ring being provided with a conical closing wall with a central hole through which the cable enters the plug/socket. Inside the cylindrical body is a cylindrical gasket, with an internal flexible lip arranged at the cable entry end, and a cable-pressing member coaxial to it, with the gasket arranged between the cable-pressing member and the cable. When the ring translates in the axial direction due to a screwing movement on the cylindrical body, its conical wall acts on the cable-pressing member imparting a movement in the radial direction and clamping the gasket on the cable.

This solution partially solves the aforementioned problems, as it does not require the removal of portions of the gasket and allows the reuse on cables with smaller diameters, however, it has a rather complex and expensive design. In addition, the actual degree of tightness depends on the correct tightening of the ring on the cylindrical body, so that the risk remains that the user does not mount the cable correctly on the plug/socket.

The purpose of the present invention is therefore to provide a movable plug/socket which is provided with a cable passage gasket which overcomes the aforementioned drawbacks. This purpose is achieved by means of a plug/socket provided with a gasket consisting of two or more monolithic discs provided with a central hole and made of a specific material and preferably with particular dimensions.

The main advantage of the socket/plug according to the present invention is to realize the sealing function at the required IP degree without any intervention on the gasket by the user, irrespective of the diameter of the cable used, nor a clamping phase of the gasket on the cable. This greatly simplifies the wiring phase and ensures that the required IP rating is obtained in all cases, regardless of the skills of the operator carrying out the wiring and without the risk of damaging the seal.

Another advantage of this socket/plug, compared to the first known gasket type, lies in the possibility of reusing it with a smaller cable than that used in the first wiring while still maintaining the gasket at the required IP rating, thanks to the elasticity of the gasket material.

A further advantage comes from the fact that no gasket components have to be cut and discarded, so there is no waste of material.

These and other advantages and features of the industrial socket/plug according to the present invention will be apparent to those skilled in the art from the following detailed description of an embodiment thereof with reference to the accompanying drawings in which:

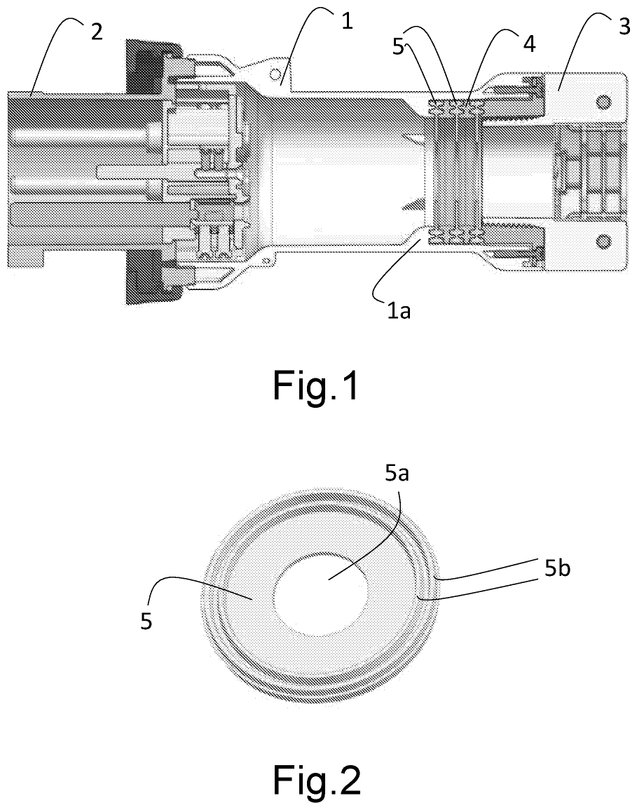

FIG. 1 is a longitudinal sectional view of a plug provided with said gasket; and

FIG. 2 is a perspective view of one of the discs making up the gasket.

Referring to the aforementioned figures, it can be seen that an industrial plug according to the present invention traditionally comprises a body 1 bearing at one end a module containing pins 2 and at the opposite end an annular ferrule 3 for clamping the cable (not shown). The ferrule 3 also has the function of clamping against a stop 1a the gasket 4, through which the cable enters the body 1 to reach the pins 2. Obviously, in the case of a socket, the module would contain longitudinal cylindrical housings, in some of which are inserted metal sleeves which act as live contacts into which the corresponding pins of the plug are inserted.

The innovative aspect of the present plug/socket is the structure of the gasket 4, which comprises three discs 5, arranged side by side and aligned along the axis of the body 1, made of a styrene-ethylene-butadiene-styrene (SEBS) thermoplastic polymer with a Shore A hardness ranging from a minimum value of ShA 25 to a maximum value of ShA 70. This type of material is already known for this application, for example from EP 4098492 and the aforementioned FR 2689331.

The thickness of the individual disc 5 is preferably between a minimum value of 0.15 mm and a maximum value of 2.50 mm, being understood as a constant thickness in the central part of the disc 5 enclosed by perimeter ribs 5b or a similar reinforced perimeter zone.

Each disc 5 has a central circular hole 5a dimensioned in such a way that sealing at the required IP rating is ensured over the full range of cables that can be wired to the socket/plug. In practice, hole 5a has a diameter suitable for sealing on the minimum required cable diameter, but thanks to the elasticity of the specific material described above, even larger cables up to the maximum required diameter can be inserted without difficulty.

In fact, hole 5a is dimensioned in such a way that the SEBS rubber fits around the outer sheath of the cable, deforming elastically when the cable is inserted, so that disc 5 assumes a “volcano” shape following the direction of insertion of the cable. In this way, a barrier to the ingress of water and dust is created on each of the three discs 5 that make up the gasket 4.

Thanks to the elasticity conferred by the material and the reduced thickness of disc 5, the operation of inserting the cable does not involve any additional action on the part of the user, who only has to push the cable through hole 5a.

It is clear that the above-described and illustrated embodiment of the socket/plug according to the invention is only an example susceptible to numerous variations. In particular, the shape, thickness and/or number of discs 5 may vary depending on the required IP rating and/or the specific industrial application, while remaining within the scope of the present inventive concept. For example, the gasket 4 may comprise only two discs 5, which may also have a non-circular outer and/or inner profile as long as they fit the seat in the body 1 and/or the outer shape of the cable.

In addition, the discs 5 could be non-aligned with the axis of the body 1 and/or have different shapes/thicknesses from each other and/or have the holes 5a formed not in a central position, provided that the holes 5a are substantially identical and substantially aligned with each other, possibly even along a curved line (in which case the discs 5 would not be parallel to each other).

1. A mobile industrial socket/plug comprising a body bearing at one end a module and at the opposite end an annular ferrule for the clamping of a power cable, which enters said body through a gasket to reach said module, wherein said gasket comprises two or more discs placed side by side and made of a styrene-ethylene-butadiene-styrene thermoplastic polymer having a Shore A hardness ranging from a minimum value of ShA 25 to a maximum value of ShA 70, each disc being provided with a hole sized so as to ensure sealing at the required IP rating over the full range of cables which may be wired to said plug/socket, said disc holes being substantially identical and substantially aligned with each other.

2. The mobile industrial socket/plug according to claim 1, wherein each disc has a thickness between a minimum value of 0.15 mm and a maximum value of 2.50 mm in the central part of the disc enclosed by a reinforced perimeter zone.

3. The mobile industrial socket/plug according to claim 1, wherein each disc has a circular shape and has a circular central hole.

4. The mobile industrial socket/plug according to claim 1, wherein the gasket comprises three identical discs arranged parallel side-by-side and aligned along the axis of the body.

5. The mobile industrial socket/plug according to claim 2, wherein each disc has a circular shape and has a circular central hole.

6. The mobile industrial socket/plug according to claim 2, wherein the gasket comprises three identical discs arranged parallel side-by-side and aligned along the axis of the body.

7. The mobile industrial socket/plug according to claim 3, wherein the gasket comprises three identical discs arranged parallel side-by-side and aligned along the axis of the body.

8. The mobile industrial socket/plug according to claim 6, wherein the gasket comprises three identical discs arranged parallel side-by-side and aligned along the axis of the body.
